(19) United States
(12) Patent Application Publication
(10) Pub. No.: US 2017/0305242 A1
(43) Pub. Date: Oct. 26, 2017

(54) Roof Support for Autonomous Vehicle Sensors

(71) Applicant: Ford Global Technologies, LLC, Dearborn, MI (US)

(72) Inventors: Steven William GALLAGHER, Bloomfield Hills, MI (US); David SCHMIDT, Dearborn, MI (US)

(21) Appl. No.: 15/137,664

(22) Filed: Apr. 25, 2016

(51) Int. Cl. B60J 7/043; B62D 25/04

(52) U.S. Cl. CPC B60J 7/043; B62D 25/04

(57) ABSTRACT

A sensor support structure for a vehicle includes a roof panel supported by bodyside pillars and a support structure. The support structure is attached to the roof via a mounting ring extending in a substantially rectangular shape around a portion of the roof panel. The mounting ring defines two sections of the support structure on the roof. The support structure further includes a cartridge defined within the sections of the mounting ring. The cartridge is configured to provide attachment of a plurality of sensors to the roof panel and is supported by the mounting ring such that a weight of the support structure, including the sensors, is distributed to the bodyside pillars.

### TECHNICAL FIELD

This disclosure relates to sensor support structures for vehicle roof panels.

### BACKGROUND

Certain vehicles may be equipped with a sunroof or moon roof. These additional features require adaptation and attachment to the roof panel.

### SUMMARY

A vehicle includes bodyside pillars, a roof and a support structure. The roof defines a periphery and is attached to and supported by the bodyside pillars. The support structure is attached to the roof. The support structure has a mounting ring that extends substantially around the periphery. The support structure further includes a panel disposed within a section defined by at least two leg portions of the mounting ring. The panel is configured to support a plurality of sensors having a weight. The mounting ring defines attachment from the roof to the bodyside pillars to distribute the weight of the panel across the roof and the bodyside pillars.

A sensor support structure for a vehicle includes a roof panel supported by bodyside pillars and a support structure. The support structure is attached to the roof via a mounting ring extending in a substantially rectangular shape around a portion of the roof panel. The mounting ring defines two sections of the support structure on the roof. The support structure further includes a cartridge defined within the sections of the mounting ring. The cartridge is configured to provide attachment of a plurality of sensors to the roof panel and is supported by the mounting ring such that a weight of the support structure, including the sensors, is distributed to the bodyside pillars.

A vehicle roof mounting structure includes a substantially rectangular ring, a cartridge and a tray. The ring defines an outer perimeter, including a divider disposed between two legs defining a first section and a second section. The cartridge is disposed within the first section between the legs and the divider and is supported by the ring and is configured to support a plurality of sensors. The tray is disposed within the second section and is configured to organize and support components for the sensors.

### BRIEF DESCRIPTION OF THE DRAWINGS

FIG. 1 is a top view of a vehicle;

FIG. 2 is an exploded view of a vehicle roof and support panel;

FIG. 3 is a bottom view of the support panel attached to the roof; and

FIG. 4 is a perspective view of a support panel and mounting ring.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

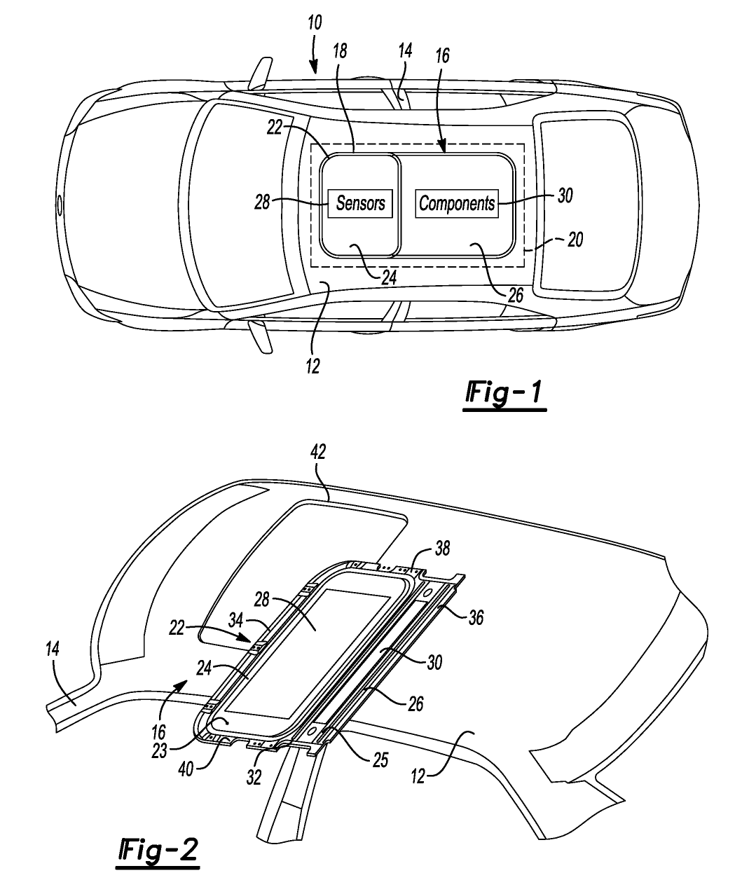

FIG. 1 depicts a top view of a vehicle 10. The vehicle 10 includes a roof panel 12, bodyside pillars 14, and a support structure 16. The roof 12 defines a periphery 18 and is supported by the bodyside pillars 14. The support structure 16 is disposed on the roof 12 inside the periphery 18. The support structure 16 is disposed within a portion 20 of the roof panel 12. For example, the support structure 16 is disposed within and supported by the roof panel 12 such that the support structure 16 and the roof 12 maintain a class-A surface. Maintaining the class-A surface allows the vehicle 10 to maintain a standard roof panel 12. The roof panel 12, and therefore the bodyside pillars 14 provide the necessary support for the weight of the support structure 16.

The support structure 16 attaches to the roof 12 via hemming the support structure 16 to the roof panel 12. By having the support structure 16 to the roof 12, the weight of the support structure may 16 be distributed across the roof panel 12 and supported by the bodyside pillars 14. The weight of the support structure 16 is defined by a mounting ring 22, a cartridge 24, a tray 26, a plurality of autonomous vehicle sensors 28, as well as the required electrical components 30 for the autonomous vehicle sensors 28. The plurality of autonomous vehicle sensors 28 may be any sensor that may be mounted on the top of the vehicle 10. The plurality of electrical components 30 may include any components required for operation of the sensors 28, including but not limited to controller, cooling systems, or cabling. The plurality of vehicle sensors 28 are disposed and supported by the cartridge 24 and the electrical components 30 are disposed and supported on the tray 26. Inclusion of autonomous vehicle sensors 28 and the electrical components 30 required may result in additional weight added to the support structure 16.

Typically, the roof panel 12 requires further support in order to account for the additional weight to the plurality of autonomous sensors 28 and the electrical components 30. However, with use of the support structure 16, including the mounting ring 22, cartridge 24 and tray 26, the additional weight is distributed through the roof panel 12 in the bodyside pillars 14 without any modification to the roof panel 12. Again, this allows the vehicle 10 to maintain a class-A surface and to use a traditional roof panel 12 despite the addition of the plurality of sensors 28 and the electrical components 30. Further, use of the support structure 16 does not require any modification or adaptation to the manufacturing process of the roof panel 12.

Referring to FIG. 2, an exploded perspective view of the support structure 16, including the cartridge 24 and tray 26, and mounting ring 22, on the roof panel 12 is depicted. The support structure 16 further includes a divider 32 that divides the support structure 16 into a first section 34 and a second section 36. As will be discussed in more detail below, the divider 32 is disposed between a first leg portion 38 and a second leg portion 40 of the mounting ring 22. Separation of the support structure 16 into the first and second sections 34, 36 provides the additional packaging space required for the electrical components 30 of the autonomous sensors 28. The cartridge 24 is disposed within the first section 34 and the tray 26 is disposed within the second section 36. As can be seen in FIG. 2, the cartridge 24 may define an area 23 greater than an area 25 of the tray 26. This is merely exemplary. In at least one other embodiment, the tray 26 may define an area 25 greater than the area 23 of the cartridge 24, as depicted in FIG. 1. The area 23 of the cartridge 24 and the area 25 of the tray may be optimized based on the relative sizes of the sensors 28 and the components 30, respectively. This allows the electrical components 30 for the sensors 28 to be disposed relatively close for optimal sensing.

Further, the roof panel 12 also defines a slot 42. The support structure 16 is configured to allow the first section 34 to be disposed within the slot 42 and the second section 36 to extend underneath the roof panel 12. Therefore, the cartridge 24 may be configured to fit within the slot 42 and the tray 26 may be configured to fit underneath the roof panel 12. The slot 42 allows the cartridge 24, and as such the sensors 28 to be exposed. Exposure of the sensors 28 is necessary to allow autonomous sensing for the vehicle 10. Likewise, including the tray 26 underneath the roof panel 12 allows the electrical components 30 to be covered. Covering the electrical components 30 mitigates deterioration and corrosion of the components 30 required to transmit data from the sensors 28. Dividing the support structure 16 using the divider 32 allows the support structure to provide adequate sensing and data transmission through the plurality of sensors and the electrical components 3 for autonomous driving.

The mounting ring 22 of the support structure 16 may be configured to extend substantially around the slot 42. For example, the mounting ring 22 may define a substantially rectangular shape to match the slot 42. More specifically, the first section 34 of the mounting ring 22 may define a substantially rectangular shape and the cartridge 24 may also define a substantially rectangular shape to fit within the slot 42 defined on the roof panel 12. Due to the open space defined by the slot 42 on the roof panel 12, the mounting ring 22 aids in distributing the weight of the cartridge 24 and the plurality of sensors 28 through the roof panel 12 to the bodyside pillars 14. Therefore, the mounting ring 22 is configured to attach to the roof panel 12, i.e. via hemming, and the cartridge 24 is configured to attach to the mounting ring 22 such that the sensors 28 are exposed through the slot 42.

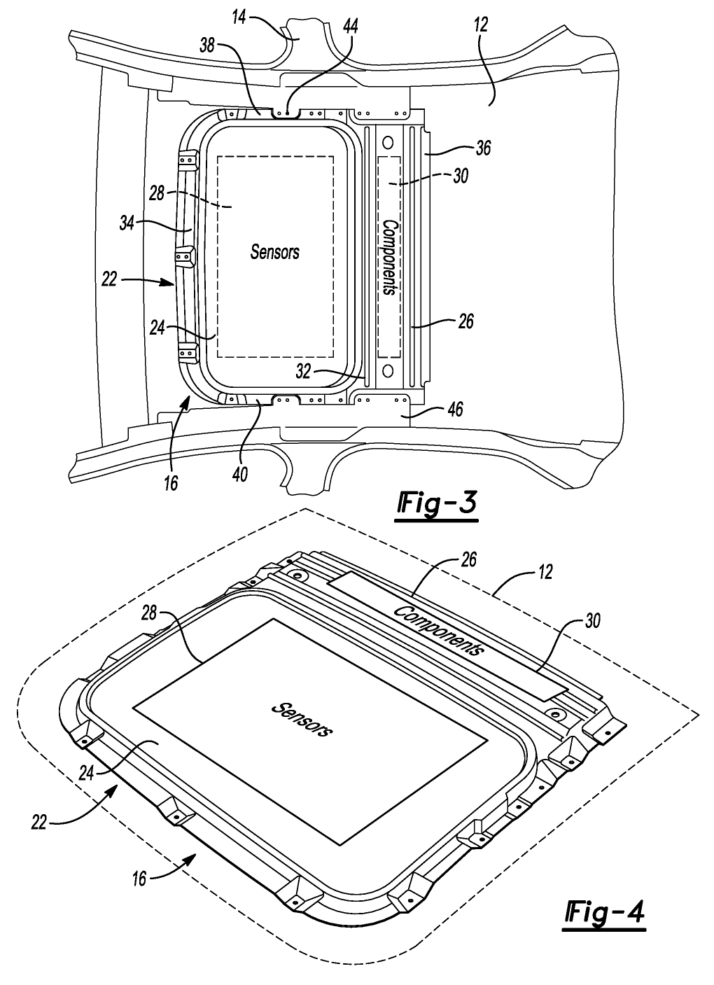

FIG. 3 depicts a bottom view of the support structure 16 attached to the roof panel 12 in the bodyside pillars 14. Separation between the first section 34 and the second section 36 by the divider 32 can be seen in FIG. 3. As stated above, the tray 26 is disposed within the second section 36 of the support structure 16. The tray 26 is disposed adjacent the cartridge 24. The divider 32 allows the tray 26 to be disposed substantially underneath the roof panel 12. Providing packaging space for the electrical components 30 to be adjacent the plurality of sensors 28 provides a more direct communication between the plurality of sensors 28 and the components 30. Also, providing a support structure 16 that allows the electrical components 30 to be covered by the roof panel aids to protect the components 30 and ensure accurate transmission of the data from the plurality of sensors 28 through the components 30. Likewise, by increasing packaging space through use of the tray 26, no additional modification to the body structure of the vehicle 10 is required to account for the additional sensors 28. The support structure 16 allows for a complete and inclusive structure to account for the requirements for autonomous driving.

Further, the first and second leg portions 38, 40 extend beyond the divider 32 and aid to support the tray 26 within the second section 36. Therefore, the mounting ring 22 aids to support the weight of the tray 26 as well as the additional weight of the electrical components 30 for the plurality of sensors 28 disposed on the cartridge 24. To support the tray 26, the mounting ring 22 may attach to the roof panel 12 at a plurality of attachment points 44. The support structure 16 may further include a pair of tracks 46. The mounting ring 22, and specifically the first and second leg portions 38, 40 attach to the roof panel 12 and subsequently to the bodyside pillars 14 through the tracks 46. The mounting ring 22 is secured to the tracks 46 through attachment at the plurality of attachment points 44. The tracks 46 aid to distribute the weight of the tray 26, as well as the weight of the cartridge 24, from the roof panel 12 to the bodyside pillars 14 without further adaptation of the roof panel 12. The tracks 46 allow the tray 26 to be disposed underneath the roof panel 12. Use of the cartridge 24 and the tray 26 further allow the manufacturing process to be uninterrupted. For example, no additional process is required to account for the addition of the plurality of sensors 28 and the associated electrical components 30 during body-in-white processing.

Referring to FIG. 4, a perspective view of the support structure 16 is depicted. The dimensions of the support structure 16 are such that the support structure 16 provides ample space for the plurality of sensors 28 and the electrical components 30 while still maintaining the rigidity of the roof panel 12.

The mounting ring 22 may be composed of a metallic compound, such as aluminum for example. In at least one other embodiment, the mounting ring 22 may be high-strength steel, carbon fiber, or a thermoplastic which allows the mounting ring 22 to account for the weight of the cartridge 24, the tray 26, the plurality of sensors 28 and the electrical components 30. The cartridge 24 may be composed of a carbon fiber composite material. In at least one other embodiment, the cartridge 24 may be a lightweight aluminum or any other lightweight panel, which allows the support structure 16 to support a plurality of sensors. The divider 32 in the tray 26 may also be composed of a lightweight aluminum, or any other lightweight material, which provides support for the electrical components 30 on the tray 26.

Using lightweight components for the support structure 16 allows the support structure 16 to support the plurality of sensors 28 and the electrical components 30 necessary for autonomous driving without adding weight to the vehicle. Maintaining rigidity while compensating for the weight of the additional sensors 28 and components 30 allows the support structure 16 to be added to the roof panel 12 without requiring modification to the bodyside pillars 14. The lightweight and rigid components of the support structure 16, namely the mounting ring 22, the cartridge 24 and the tray 26, provide the necessary support for the plurality of sensors 28 and the space for the electrical components 30 without changing the manufacturing process of the vehicle 10.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. A vehicle comprising:
bodyside pillars;
a roof defining a periphery and attached to and supported by the bodyside pillars; and
a support structure attached to the roof, the support structure having a mounting ring extending substantially around the periphery, and a panel disposed within a section defined by at least two leg portions of the mounting ring, the panel being configured to support a plurality of sensors having a weight, and the mounting ring defining attachment from the roof to the bodyside pillars to distribute the weight of the panel across the roof and the bodyside pillars.

2. The vehicle of claim 1, wherein the mounting ring further includes a divider configured to extend between the leg portions of the mounting ring to define a second section having a tray to organize components of the sensors.

3. The vehicle of claim 1 further comprising a bracket that attaches the support structure to the roof at a plurality of attachment points that distribute the weight of the panel.

4. The vehicle of claim 1 further comprising a bracket that attaches the leg portions of the support structure to the roof

5. The vehicle of claim 1, wherein the sensors are configured to provide autonomous sensing to the vehicle.

6. The vehicle of claim 2, wherein the roof extends over the tray and the panel substantially fits into a slot defined in the roof.

7. A sensor support structure for a vehicle comprising:
a roof panel supported by bodyside pillars; and
a support structure attached to the roof via a mounting ring extending in a substantially rectangular shape around a portion of the roof panel, the mounting ring defining two sections of the support structure on the roof, the support structure including a cartridge defined within one of the sections of the mounting ring, the cartridge being configured to provide attachment of a plurality of sensors to the roof panel and supported by the mounting ring such that a weight of the support structure, including the sensors, is distributed to the bodyside pillars.

8. The sensor support structure of claim 7 further comprising a divider extending between leg portions of the mounting ring to separate the sections.

9. The sensor support structure of claim 8 further comprising a tray disposed adjacent the cartridge within another of the sections defined by the divider.

10. The sensor support structure of claim 9, wherein the tray is configured to support a plurality of electrical components for the plurality of sensors beneath the roof panel.

11. The sensor support structure of claim 7, wherein the cartridge is defined within a section of the mounting ring that extends into an open space defined in the roof panel.

12. A vehicle roof mounting structure comprising:
a substantially rectangular ring defining an outer perimeter, including a divider disposed between two legs defining a first section and a second section;
a cartridge disposed within the first section between the legs and the divider, supported by the ring and configured to support a plurality of sensors; and
a tray disposed within the second section, the tray being configured to organize and support components for the sensors.

13. The vehicle roof mounting structure of claim 12, wherein the cartridge defines an area greater than an area of the tray.

14. The vehicle roof mounting structure of claim 12 further comprising at least one bracket attachable to the ring at a plurality of attachment points and configured to support the tray.

15. The vehicle roof mounting structure of claim 12, wherein the cartridge is defined within the first section of the mounting ring that extends into an open space defined in a roof.

16. The vehicle roof mounting structure of claim 12, wherein the tray is defined within the second section of the mounting ring that extends into an area covered by a roof.

17. The vehicle roof mounting structure of claim 12, wherein the tray is disposed adjacent to the cartridge.
